(19) United States
(12) Patent Application Publication
(10) Pub. No.: US 2011/0268907 A1
(43) Pub. Date: Nov. 3, 2011

(54) DECORATED DEVICE

(75) Inventor: Chih-Chung Chang, Taoyuan County (TW)

(73) Assignee: ETANSI INC., Taoyuan County (TW)

(21) Appl. No.: 13/082,436

(22) Filed: Apr. 8, 2011

Related U.S. Application Data
(60) Provisional application No. 61/329,100, filed on Apr. 29, 2010.

(51) Int. Cl. B32B 3/26; B32B 3/02

(52) U.S. Cl. 428/57; 428/195.1; 428/172; 428/139; 428/201

(57) ABSTRACT

An decorated device including a first body, a second body, a first decoration layer, and a second decoration layer is provided. The second body is disposed beside the first body. The first decoration layer contacts with the first body. The second decoration layer contacts with the second body, wherein the first body contacts with at least two of the second body, the first decoration layer, and the second decoration layer.

### CROSS-REFERENCE TO RELATED APPLICATION

This application claims the priority benefit of U.S. Provisional Application Ser. No. 61/329,100, filed Apr. 29, 2010. The entirety of the above-mentioned patent application is hereby incorporated by reference herein and made a part of this specification.

### BACKGROUND OF THE INVENTION

1. Field of the Invention

The present invention generally relates to a decoration device and a method of fabricating a decoration device, in particular, to a decoration device with at least two decoration layers and a method of fabricating the same.

2. Description of Related Art

Conventionally, the illustrations or decorations formed on the surface of the plastic device are mainly fabricated by spraying process or printing process to present certain visual effect. Nevertheless, the spraying process is unfavorable in mass production for the disadvantages of time consumption and process complexity. In addition, the conventional spraying process may cause the splashing of sprays containing lead or other heavy metals so that the spraying material is wasted and the problem of pollution is caused. Furthermore, during the spraying process, the mass of the coating material is not easily controlled so that the thickness is usually uneven. Particularly, when the spraying process is performed on the curve portion of the device, the improper accumulation of the coating material is worse.

To solve the abovementioned problem, an in-mold rolling (IMR) decoration technique is provided. The process of the IMR technique includes placing a film with predetermined decorations into the mold of the injection molding machine, injecting a plastic material at a side of the film in the mold so that the predetermined decorations are adhered on the plastic material to form a decorated device. Accordingly, the in-mold rolling decoration process is completed.

### SUMMARY OF THE INVENTION

Accordingly, the present invention is directed to a decorated device having multiple decoration layers.

According to an embodiment of the present invention, an decorated device including a first body, a second body, a first decoration layer, and a second decoration layer is provided. The second body is disposed beside the first body. The first decoration layer, contacts with the first body. The second decoration layer contacts with the second body, wherein the first body contacts with at least two of the second body, the first decoration layer, and the second decoration layer.

According to an embodiment of the present invention, the first body and the second body are made of different materials.

According to an embodiment of the present invention, the first body or the second body has a plurality of protruding structures. In addition, the second decoration film may have a plurality of openings and the protruding structures are located in the openings.

According to an embodiment of the present invention, at least one of the first body and the second body is located between the first decoration film and the second decoration film.

According to an embodiment of the present invention, the first decoration film and the second decoration film are located at two opposite sides of the first body.

According to an embodiment of the present invention, the second decoration film is located between the first body and the second body.

According to an embodiment of the present invention, the first decoration film and the second decoration are located at a same side of the first body and the second decoration film is partially overlapped the first decoration film.

According to an embodiment of the present invention, the first body and the second body are both located between and contact with the first decoration film and the second decoration film.

According to an embodiment of the present invention, the decorated device further includes a third body located at a side of the second decoration film away from the second body. A material of the third body can be different from a material of the first body or a material of the second body. The third body has a plurality of protruding structures and the protruding structures and the second decoration film are located at two opposite sides of the third body.

According to an embodiment of the present invention, a side of the second body away from the second decoration film is exposed as an outer surface.

According to an embodiment of the present invention, a side of the second body away from the second decoration film contacts with the first body.

In order to make the aforementioned and other features and advantages of the invention more comprehensible, embodiments accompanying figures are described in detail below.

Herein, the same or similar reference numbers used in the drawings and the descriptions are referred as the same or similar elements. For clearly describing the concept of the invention, the shapes and the thickness of the elements in the embodiments accompanying with the drawings may not definitely comply with the real circumstance. In addition, the following descriptions are directed to the elements or the combinations thereof, but the elements are not particularly restricted in the contents or the descriptions. Any form or shape known by one skilled in the art is applicable in the invention. Moreover, the description that a material layer disposed on a substrate or disposed on another material layer means that the material layer is directly located on the substrate or the another material layer, and may also mean that some interlayer is interrupted between the material layer and the substrate or between the material layer and the another material layer.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A schematically illustrates a decorated device according to a first embodiment of the invention.

FIG. 1B schematically shows a method a double injection molding process combining with an in-mold rolling decoration technique for manufacturing the decorated device in FIG. 1A.

FIG. 2 schematically illustrates a decorated device according to a second embodiment of the invention.

FIG. 3 schematically illustrates a decorated device according to a third embodiment of the invention.

FIG. 4 schematically illustrates a decorated device according to a fourth embodiment of the invention.

FIG. 5 schematically illustrates a decorated device according to a fifth embodiment of the invention.

FIG. 6 schematically illustrates a decorated device according to a sixth embodiment of the invention.

FIG. 7 schematically illustrates a decorated device according to a seventh embodiment of the invention.

FIG. 8 schematically illustrates a decorated device according to an eighth embodiment of the invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

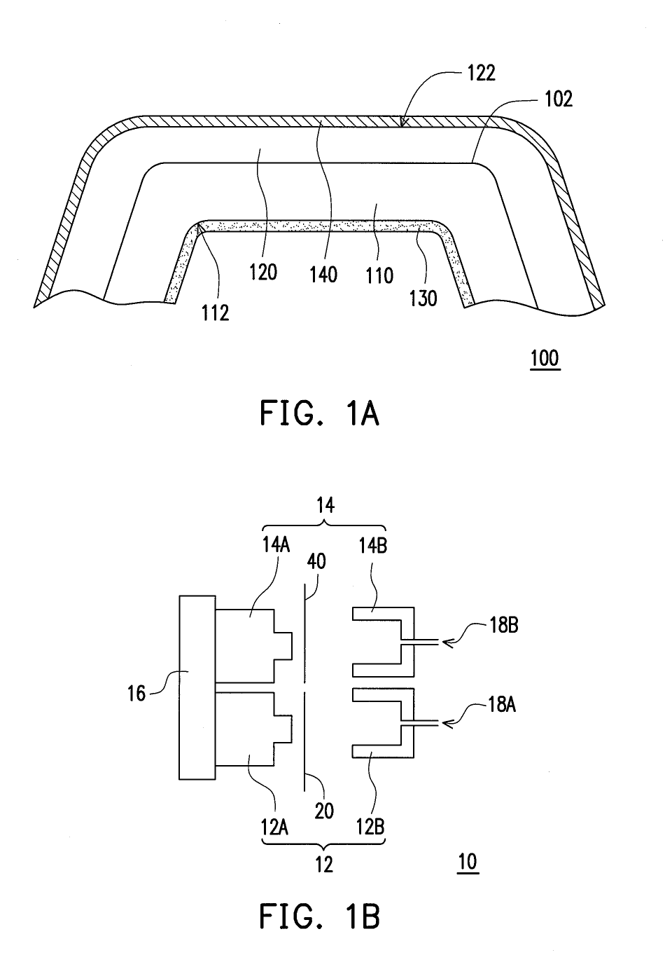

FIG. 1A schematically illustrates a decorated device according to a first embodiment of the invention. Referring to FIG. 1A, a decorated device 100 includes a first body 110, a second body 120, a first decoration layer 130, and a second decoration layer 140. The first body 110 and the second body 120 are made of different materials, for example, different plastic materials and contact with each other at a contacting surface 102. The first decoration layer 130 covers a side 112 of the first body 110 and the second decoration layer 140 covers a side 122 of the second body 120. In the present embodiment, the side 112 and the side 122 are two opposite sides of the decorated device 100.

In the present embodiment, the first body 110 and the second body 120 can have different colors or different properties. For example, the material of the first body 110 and the second body 120 can be a plastic material such as polycarbonate (PC), polypropylene (PP), polymethylmethacrylate (PMMA), MMA-St, MS, acrylonitrile butadiene styrene (ABS), polystyrene (PS), polyethylene terephthalate (PET), polyoxymethylene (POM) or a combination thereof, but is not restricted herein. The first decoration layer 130 and the second decoration layer 140 can have patterns, an uneven surface, or a smooth surface for decorating the decorated device 100.

Specifically, the decorated device 100 can be fabricated by a method combining an in-mold rolling decoration process and a double injection molding process. FIG. 1B schematically shows a method a double injection molding process combining with an in-mold rolling decoration technique for manufacturing the decorated device in FIG. 1A. Referring to FIG. 1A and FIG. 1B simultaneously, a double injection molding apparatus 10 including a first mold 12 and a second mold 14 disposed on a base 16, wherein the first mold 12 and the second mold 14 are respectively configured with a first injection channel 18A and a second injection channel 18B. Generally, the first mold 12 includes a first fixed mold 12A and a first moving mold 12B. The second mold 14 includes a second fixed mold 14A and a second moving mold 14B.

When fabricating the decorated device 100, a first decoration film 20 having the decoration layer 130 shown in FIG. 1A can be disposed in the first mold 12 and located between the first fixed mold 12A and the first moving mold 12B. Then, a first injection molding step is performed. In the first injection molding step, a first plastic material is injected into the mold space (not marked) defined by the first fixed mold 12A and the first moving mold 12B through the first injection channel 18A to form the first body 110 adhered with the first decoration layer 130. Thereafter, the first body 110 adhered with the first decoration layer 130 is moved to the second mold 14 through a mechanical arm (not shown) or through rotating the base 16 up side down. Subsequently, a second decoration film 40 having the decoration layer 140 is provided to be disposed between the second fixed mold 14A and the second moving mold 14B. In addition, a second injection molding step is performed. In the second injection molding process, a second plastic material different from the first plastic material is injected into the mold space (not marked) defined by the second fixed mold 14A and the second moving mold 14B through the second injection channel 18B to form the second body 120 adhered with the second decoration layer 140. Accordingly, the decorated device 100 is fabricated. It is noted that the positions of the elements in the double injection molding apparatus 10 are merely schematically shown in FIG. 1B, but not restricted herein. In other embodiments, the first injection channel 18A and the second injection channel 18B, for example, can be optionally configured in the first fixed mold 12A and the second fixed mold 14A.

After the two injection molding steps, the decorated device 100 having the first decoration layer 130 and the second decoration layer 140 is formed so that various requirements such as the requirement of having different materials with different patterns at different sides can be satisfied. In addition, no additional apparatus is needed for fabricating the decorated device 100 according to the above-mentioned method so as to simplify the manufacturing method. Nevertheless, the method for manufacturing the decorated device 100 is not limited to the aforesaid steps. In other embodiments, the first decoration film 20 can be optionally disposed in the second mold 14, and the first decoration layer 130 and the second decoration layer 140 are simultaneously formed on the first body 110 and the second body 120 during the second injection molding step.

Certainly, the first body 110 can be formed by a single injection molding process combined with an in-mold rolling decoration technique so as to be adhered with the first decoration layer 130. Next, another single injection molding process combined with the in-mold rolling decoration technique is performed by disposing the first body 110 in the mold to form the second body 120 adhered with the second decoration layer 140 on the first body 110. Therefore, the first body 110 and the second body 120 contact with each other at the contacting surface 102. That is to say, the single injection molding process combined with the in-mold rolling decoration technique can be performed twice to fabricate the decorated device 100.

In addition, a co-injection molding process combined with a double sides in-mold rolling decoration technique can be performed to fabricated the decorated device 100. That is to say, the first body 110 and the second body 120 can be formed in the same mold by sequentially injecting two different plastic materials into the mold. In the co-injection molding process, two decoration layers respectively having the first decoration layer 130 and the second decoration layer 140 are disposed in the mold so as to adhere on the first body 110 and the second body 120. That is to say, the method for fabricating the decorated device 100 is not specifically limited.

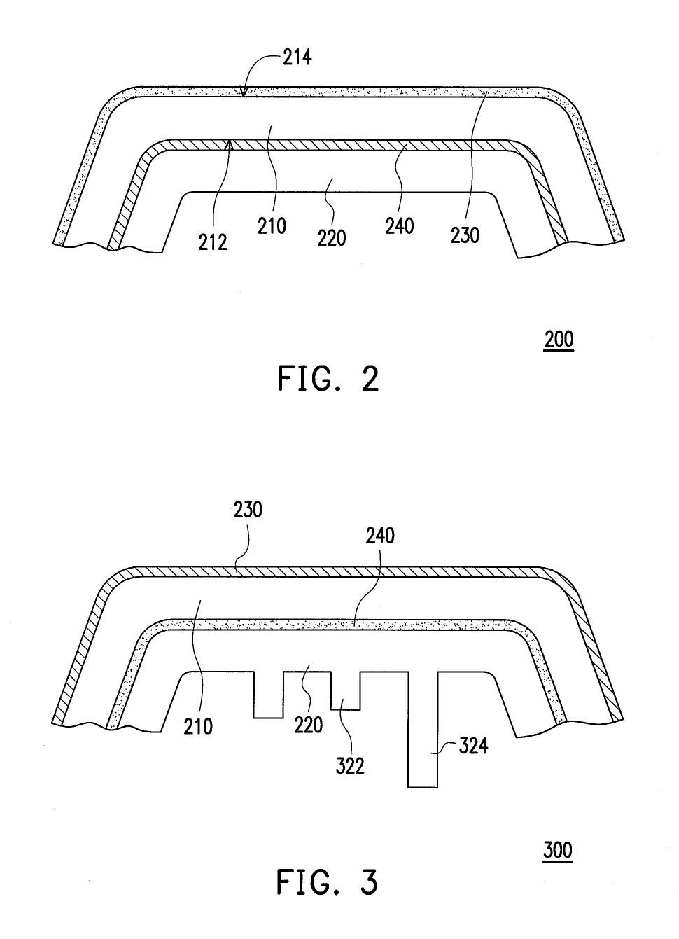

FIG. 2 schematically illustrates a decorated device according to a second embodiment of the invention. Referring to FIG. 2, a decorated device 200 includes a first body 210, a second body 220, a first decoration layer 230, and a second decoration layer 240. The first decoration layer 130 and the second decoration layer 140 are respectively disposed at two opposite sides 212 and 214 of the first body 210. In addition, the second decoration layer 240 is located between the first body 210 and the second body 220. Furthermore, the first body 210 and the second body 220 are made of different materials. Certainly, the first decoration layer 230 and the second decoration layer 240 can have different patterns or different properties.

Specifically, the first decoration layer 230 and the second decoration layer 240 are formed on the first body 210 by performing a double sides in-mold rolling decoration process. Namely, two decoration films are disposed in a mold of the injection molding apparatus and a plastic material is injected between the two decoration films so as to form the first body 210 with the first decoration layer 230 and the second decoration layer 240. Thereafter, the first body 210 with the first decoration layer 230 and the second decoration layer 240 is disposed in another mold and another injection molding process is performed to form the second body 220 contacting with the second decoration layer 240.

Nevertheless, the decorated device 200 can be fabricated through other process. For example, the first body 210 adhered with the first decoration layer 230 is formed by an IMR process. Then, another IMR process is performed on the first body 210 adhered with the first decoration layer 230 to form the second body 220 and the second decoration layer 240. That is to say, the IMR process can be performed twice to fabricate the decorated device 200.

Furthermore, the decorated device 200 can be formed by using the double injection molding apparatus 10 shown in FIG. 1B. For example, referring to FIG. 1B and FIG. 2 simultaneously, the first body 210 and the first decoration layer 230 can be formed in the first mold 12 during a first injection molding step and then a second injection molding step is performed in the second mold 14 after moving the first body 210 adhered with the first decoration layer 230 to the second mold 14 to form the second body 220 and the second decoration layer 240. Alternately, the first decoration layer 230 and the second decoration layer 240 can be formed simultaneously with the formation of the first body 210 during the first injection molding step by disposing the first decoration film 20 and the second decoration film 40 in the first mold 12.

FIG. 3 schematically illustrates a decorated device according to a third embodiment of the invention. Referring to FIG. 3, the decorated device 300 is substantially similar to the decorated device 200 so that the same reference numbers in FIG. 2 and FIG. 3 represent the same elements which can be fabricated by the same process and are not reiterated. It is noted that the difference between the decorated device 200 as shown in FIG. 2 and the decorated device 300 shown in FIG. 3 lies in that the decorated device 300 further has a plurality of protruding structures 322 and at least an ejection pillar 324 disposed at a side of the second body 220 away from the first body 210. The protruding structures 322 are configured for providing specific mechanical function. For example, the protruding structures 322 is conducive to be assembled with other device or be served as specific strengthen ribs. The ejection pillar 324 is configured for performing an ejection step to eject the decorated device 300 from the mold.

Specifically, the protruding structures 322 and the ejection pillar 324 can be formed integrally with the second body 210. That is to say, the protruding structures 322 and the ejection pillar 324 are formed by the process of forming the second body 220. Alternately, the protruding structures 322 and the ejection pillar 324 can be formed by another injection molding process after forming the second body 220. It is noted that the protruding structures 322 and the ejection pillar 324 can be formed on the decorated device 100 as shown in FIG. 1A according the design of the products in other embodiments.

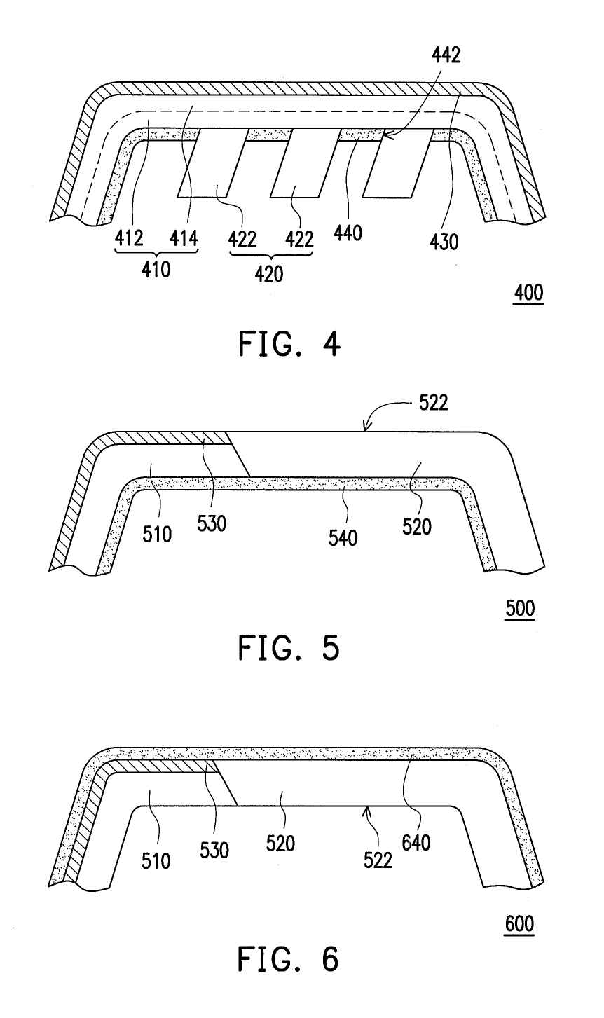

FIG. 4 schematically illustrates a decorated device according to a fourth embodiment of the invention. Referring to FIG. 4, a decorated device 400 includes a first body 410, a second body 420, a first decoration layer 430, and a second decoration layer 440. The first decoration layer 430 and the second decoration layer 440 are disposed at two opposite sides of the first body 410 while the second decoration layer 440 has a plurality of openings 442. The second body 420 includes a plurality of protruding structures 422 disposed in the openings 442 of the second decoration layer 440.

In the present embodiment, the first body 410, the first decoration layer 430, and the second decoration layer 440 can be formed by performing a double sides in-mold rolling decoration process. Thereafter, a single injection molding process can be performed on the first body 410 adhered with the first decoration layer 430 and the second decoration layer 440 to form the second body 420. In addition, a double injection molding process can be selectively performed for fabricating the first body 410 of the decorated device 400. That is to say, the first body 410 can include the portion 412 and the portion 414 as shown by the dash line in FIG. 4, wherein the portion 412 and the portion 414 are made of different materials so as to have different colors or different properties. It is noted that a material of the protruding structures 422 can be the same as that of the portion 412 or the portion 414, but can be differed from that of the portion 412 or the portion 414. In other embodiments, the first body can be formed by a co-injection molding process with the double sides in-mold rolling decoration technique so that the portions 412 and 414 and two decoration layers 430 and 440 can be fabricated simultaneously in the same mold to form the decorated device 400.

FIG. 5 schematically illustrates a decorated device according to a fifth embodiment of the invention. Referring to FIG. 5, a decorated device 500 includes a first body 510, a second body 520, a first decoration layer 530, and a second decoration layer 540. The first body 510 and the second body 520 contact with each other and are arranged beside each other. The first decoration layer 530 is adhered on the first body 510 and the second decoration layer 540 is simultaneously adhered on the first body 510 and the second body 520. It is noted that a side 522 of the second body 520 away from the second decoration layer 540 can be exposed and not adhered by a decoration layer in the present embodiment.

Specifically, to fabricate the decorated device 500 having at least two bodies with different materials and two decoration layers with different colors or different properties, a double injection molding process combined with in-mold rolling decoration technique can be performed. For example, the double injection molding apparatus 10 as shown in FIG. 1B can be used. Referring to FIG. 1B and FIG. 5 simultaneously, a first injection molding process is performed. In the first injection molding process, a first plastic material can be injected into the first mold 12 through the first injection channel 18A while a first decoration film 20 having the first decoration layer 530 is disposed between the first fixed mold 12A and the first moving mold 12B. Accordingly, the first decoration layer 530 is adhered on the first body 510. Thereafter, a second injection molding process is performed. In the second injection molding process, the first body 510 adhered with the first decoration layer 530 is moved to the second mold 14 and a second plastic material is injected into the second mold 14 through the second injection channel 18B while a second decoration film 40 having the second decoration layer 540 is disposed between the second fixed mold 14A and the second moving mold 14B.

It is noted that the first decoration layer 530 is formed during the first injection molding process and the second body 520 is formed subsequently. Accordingly, the first decoration layer 530 is merely adhered on the first body 510 and the side 522 of the second body 520 away from the second decoration layer 540 is exposed. That is, no decoration layer is adhered on the side 522 in the present embodiment.

FIG. 6 schematically illustrates a decorated device according to a sixth embodiment of the invention. Referring to FIG. 6, a decorated device 600 similar to decorated device 500 is provided. The difference between the decorated device 600 and the decorated device 500 is that the second decoration layer 640 and the first decoration layer 530 is located at the same side of the decorated device 600. That is to say, the disposition relationships of the first body 510 and the second body 520 can be referred to the description in FIG. 5. Herein, the second decoration layer 640 can selectively cover the first decoration layer 530. The overlapping of the first decoration layer 530 and the second decoration layer 640 is conducive to provide various visual effects, gradient visual effect, or the like. It is noted that the method for fabricating the decorated device 600 can be referred to the method for fabricating the decorated device 500. That is to say, the first body 510 adhered with the first decoration layer 530 is formed prior to the formation of the second body 520 and the second decoration layer 540 in a double injection molding process.

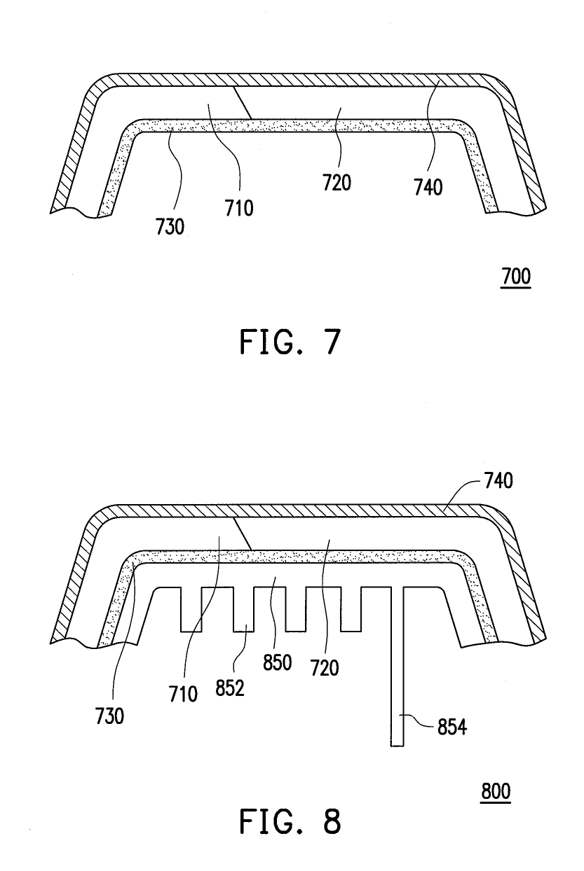

FIG. 7 schematically illustrates a decorated device according to a seventh embodiment of the invention. Referring to FIG. 7, a decorated device 700 includes a first body 710, a second body 720, a first decoration layer 730, a second decoration layer 740. The first body 710 is disposed beside the second body 720. Both the first decoration layer 730 and the second decoration layer 740 cover and contact with the first body 710 and the second body 720. Specifically, the first decoration layer 730 and the second decoration layer 740 are located at two opposite sides of the decorated device 700.

In the present embodiment, the decorated device 700 can be fabricated by a co-injection molding process combined with double sides in-mold rolling decoration technique. That is to say, the first body 710 and the second body 720 are formed in the same mold by injecting two plastic materials into different regions of the mold, that is, the co-injection molding process. In addition, two decoration films respectively having the first decoration layer 730 and the second decoration layer 740 can be disposed in the mold and the two plastic materials are substantially injected between the two decoration films. Therefore, the decorated device 700 is fabricated.

Furthermore, FIG. 8 schematically illustrates a decorated device according to an eighth embodiment of the invention. Referring to FIG. 8, a decorated device 800 includes a first body 710, a second body 720, a first decoration layer 730, a second decoration layer 740, a third body 850, a plurality of protruding structures 852, and at least an ejection pillar 854. The first body 710, the second body 720, the first decoration layer 730, and the second decoration layer 740 can be referred to the decorated device 700 in the seventh embodiment depicted in FIG. 7. Therefore, the disposition relationships of the first body 710, the second body 720, the first decoration layer 730, and the second decoration layer 740 are not iterated here. In addition, the third body 850 is disposed on the first decoration layer 730 away from the first body 710 and the second body 720 while the protruding structures 852 and the ejection pillar 854 are disposed on the third body 850. Herein, the ejection pillar 854 facilitates the decorated device 800 to eject from the mold in an injection molding process and the protruding structures 852 are conducive to provide specific mechanical properties.

In the present embodiment, the semi-fabricated device consisted of the first body 710, the second body 720, the first decoration layer 730, and the second decoration layer 740 can be formed by the co-injection molding process combined with the in-mold rolling decoration technique. Thereafter, another injection molding process is performed on the semi-fabricated device so as to form the third body 850, the protruding structures 852, and the ejection pillar 854. It is noted that the third body 850, the protruding structures 852, and the ejection pillar 854 can be formed in the same injection molding process. Nevertheless, the third body 850 can be formed in one injection molding process while the protruding structures 852 and the ejection pillar 854 can be formed in another injection molding process in other embodiments. Accordingly, two materials can be used to form the third body 850 by one material and form the protruding structures 852 and the ejection pillar 854 by the other material so that four plastic materials can be used to fabricated the decorated device 800. However, the types of the materials used to fabricate a decorated device are not limited thereto.

In view of the above, an in-mold rolling technique can be combined with a single injection molding process, a double injection molding process, or a co-injection molding process so that a decorated device can have at least two plastic material bodies and two decoration layers. In addition, the two decoration layer can be disposed at two sides of the device so as to provide different decoration effects.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An decorated device comprising:
a first body;
a second body disposed beside the first body;
a first decoration layer contacting with the first body; and
a second decoration layer contacting with the second body, wherein the first body contacts with at least two of the second body, the first decoration layer, and the second decoration layer.

2. The decorated device according to claim 1, wherein the first body and the second body are made of different materials.

3. The decorated device according to claim 1, wherein the first body or the second body has a plurality of protruding structures.

4. The decorated device according to claim 3, wherein the second decoration film has a plurality of openings and the protruding structures are located in the openings.

5. The decorated device according to claim 1, wherein at least one of the first body and the second body is located between the first decoration film and the second decoration film.

6. The decorated device according to claim 1, wherein the first decoration film and the second decoration film are located at two opposite sides of the first body.

7. The decorated device according to claim 1, wherein the second decoration film is located between the first body and the second body.

8. The decorated device according to claim 1, wherein the first decoration film and the second decoration are located at a same side of the first body and the second decoration film is partially overlapped the first decoration film.

9. The decorated device according to claim 1, wherein the first body and the second body are both located between and contact with the first decoration film and the second decoration film.

10. The decorated device according to claim 1, further comprising a third body located at a side of the second decoration film away from the second body.

11. The decorated device according to claim 10, wherein a material of the third body is different from a material of the first body or a material of the second body.

12. The decorated device according to claim 10, wherein the third body has a plurality of protruding structures and the protruding structures and the second decoration film are located at two opposite sides of the third body.

13. The decorated device according to claim 1, wherein a side of the second body away from the second decoration film is exposed as an outer surface.

14. The decorated device according to claim 1, wherein a side of the second body away from the second decoration film contacts with the first body.
